(19) United States
(12) Patent Application Publication
(10) Pub. No.: US 2009/0188779 A1
(43) Pub. Date: Jul. 30, 2009

(54) Multi-Function Selecting Mechanism

(76) Inventor: Alan A. McReynolds, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/244,899

(22) Filed: Oct. 3, 2008

Related U.S. Application Data
(60) Provisional application No. 61/024,857, filed on Jan. 30, 2008.

(51) Int. Cl. H01H 9/00

(52) U.S. Cl. 200/310; 200/308

(57) ABSTRACT

A multi-function selecting mechanism is provided. The multi-function selecting mechanism comprises a toggling feature and a selection mechanism coupled with said toggling feature. The selection mechanism is configured to move about the toggling feature to a first position or move toward the toggling feature to a second position, wherein a first function is initiated when the selection mechanism is in the first position and a second function is initiated when the selection mechanism is in the second position.

### CROSS-REFERENCE TO RELATED APPLICATION

The present application claims priority from provisional application Ser. No. 61/024,857, filed Jan. 30, 2008, the contents of which are incorporated herein by reference in their entirety.

### TECHNICAL FIELD

The technology relates to the field of function selection. In particular, the technology relates to the field wherein a specific function is selected from among multiple functions.

### BACKGROUND

A device generally includes a piece of equipment or a mechanism designed to serve a particular purpose or perform a particular function. Modern electronic devices generally utilize the flow of electric charge through various materials and mechanisms, such as to carry out a useful task. For example, an electronic device, or component thereof, may be used to initiate and/or execute a function wherein the execution of this function helps to bring about a useful result.

Due to the ability of many modern computer systems to process electronic data at a relatively high rate of speed, such computer systems have become a useful tool for performing operations electronically. Examples of modern computing systems include personal computers, server computers and network computers. These computer systems may be used for such purposes as word processing, database entry, or accessing information content over the Internet.

### SUMMARY

This Summary is provided to introduce a selection of concepts that are further described below in the Detailed Description. This Summary is not intended to identify key or essential features of the claimed subject matter, nor is it intended to be used as an aid in determining the scope of the claimed subject matter.

A multi-function selecting mechanism is provided. The multi-function selecting mechanism comprises a toggling feature and a selection mechanism coupled with said toggling feature. The selection mechanism is configured to move about the toggling feature to a first position or move toward the toggling feature to a second position, wherein a first function is initiated when the selection mechanism is in the first position and a second function is initiated when the selection mechanism is in the second position.

### DESCRIPTION OF THE DRAWINGS

The accompanying drawings, which are incorporated in and form a part of this specification, illustrate embodiments of the technology for information module recommendation, and together with the description serve to explain principles discussed below:

FIG. 1A is a side view of a first exemplary multi-function selecting mechanism in accordance with an embodiment of the present technology.

FIG. 1B is a top view of a first exemplary display configuration in accordance with an embodiment of the present technology.

FIG. 2A is a side view of a second exemplary multi-function selecting mechanism in accordance with an embodiment of the present technology.

FIG. 2B is a top view of a second exemplary display configuration in accordance with an embodiment of the present technology.

FIG. 3 is a side view of a third exemplary multi-function selecting mechanism in accordance with an embodiment of the present technology.

FIG. 4A is a bottom view of a fourth exemplary multi-function selecting mechanism in accordance with an embodiment of the present technology.

FIG. 4B is a top view of a third exemplary display configuration in accordance with an embodiment of the present technology.

FIG. 5 is a block diagram of an exemplary computer system in accordance with an embodiment of the present technology.

The drawings referred to in this description are to be understood as not being drawn to scale except if specifically noted.

### DETAILED DESCRIPTION

Reference will now be made in detail to embodiments of the present technology, examples of which are illustrated in the accompanying drawings. While the present technology will be described in conjunction with various embodiments, the present technology is not limited to these embodiments. On the contrary, the present technology is intended to cover alternatives, modifications and equivalents, which may be included within the spirit and scope of the various embodiments as defined by the appended claims.

Furthermore, in the following detailed description, numerous specific details are set forth in order to provide a thorough understanding of the present technology. However, the present technology may be practiced without these specific details. In other instances, well known methods, procedures, components, and circuits have not been described in detail so as not to unnecessarily obscure aspects of the presented embodiments.

### Overview

Many modern electronic devices may be used for performing a function electronically. For example, electronic computer systems are often used to process electronic data so as to initiate and/or perform a particular function, wherein the execution of such function is used to realize a particular result, such as word processing or numerical data entry. Moreover, an input device may be communicatively coupled with such computer systems so as to allow a user to select particular function such that the execution of such function is subsequently initiated.

Various function selection paradigms are presented herein. Pursuant to an embodiment, an input device is configured to be used to select between multiple functions, such as a plurality of available functions that may be performed using a computer system, or other function-performing device. In this manner, the number input devices, and supporting equipment, used to initiate such functions may be minimized.

For example, in an embodiment, a multi-function selection mechanism is provided, wherein the multi-function selection mechanism includes a selection mechanism coupled with a toggling feature, wherein the selection mechanism is configured to move about the toggling feature to a first position or a second position. When the selection mechanism is in the first position, a first function is initiated. Moreover, a second function is initiated when the selection mechanism is in the second position. Thus, selection mechanism may be moved in different directions about the toggling feature in order to initiate different functions.

In one embodiment, the multi-function selection mechanism further includes an indicator that is coupled with the selection mechanism, wherein the indicator provides a first indication associated with the first function and a second indication associated with a second function. This indicator is used, for example, to communicate which functions may be implemented using the multi-function selection mechanism, as well as how the selection mechanism is to be positioned about the toggling feature so as to initiate a particular function.

The foregoing notwithstanding, in an embodiment, a multi-function selection mechanism is provided, wherein the multi-function selection mechanism includes first and second toggling features coupled with a selection mechanism. The selection mechanism is configured to move about the first and second toggling features to a first position, a second position or a third position, wherein a first function is initiated when the selection mechanism is in the first position, a second function is initiated when the selection mechanism is in the second position, and a third function is initiated when the selection mechanism is in the third position. In this manner, the selection mechanism may be physically displaced about the two toggling features in three different selecting positions so as to select a function from among three available functions, wherein the three available functions correspond to the aforementioned selecting positions.

In addition, in one embodiment, a multi-function selection mechanism is provided, wherein the multi-function selection mechanism includes a selection mechanism coupled with a toggling feature, wherein the selection mechanism is configured to move about the toggling feature to a first position, or move toward the toggling feature to a second position. For example, an embodiment provides that the toggling feature includes a pivot button assembly, wherein the selection mechanism may rotate about the pivot button assembly to the first selecting position so as to initiate a first function, or compress the pivot button assembly to arrive at the second selecting position such that a second function is initiated.

Reference will now be made to exemplary embodiments pertaining to various multi-function selecting configurations. While the present technology may be described in conjunction with various embodiments discussed herein, the present technology is not limited to these embodiments. Rather, the present technology is intended to cover alternatives, modifications and equivalents of the presented embodiments.

### Exemplary Multi-Function Selecting Configurations

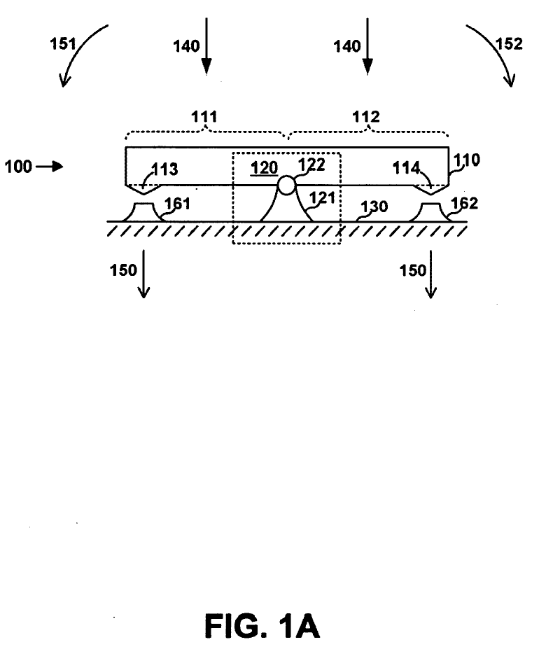

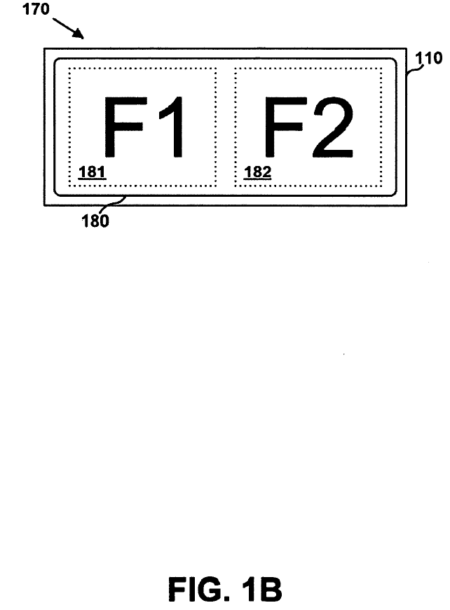

With reference now to FIG. 1A, a first exemplary multi-function selecting mechanism 100 in accordance with an embodiment is shown. First exemplary multi-function selecting mechanism 100 includes a selection mechanism 110 coupled with a toggling feature 120. Selection mechanism 110 is configured to move about toggling feature 120 to a first position, wherein a first function is initiated when selection mechanism 110 is in the first position. Similarly, selection mechanism 110 may be moved to a second position, wherein a second function is initiated when selection mechanism 110 is in the second position. Thus, an embodiment provides that selection mechanism 110 provides a means for selecting between two or more available functions, wherein the selected function is initiated or executed in response to the selection.

With reference still to FIG. 1A, toggling feature 120 is positioned between selection mechanism 110 and a base structure 130 such that toggling feature 120 supports selection mechanism 110 relative to base structure 130. Moreover, selection mechanism 110 rests upon toggling feature 120 in an initial, neutral position, wherein none of the available functions are selected. In response to a mechanical force applied to selection mechanism 110, selection mechanism 110 toggles about toggling feature 120 to either the first or second selecting position, depending on the position and vector direction of the mechanical force in relation to selection mechanism 110.

To further illustrate, in an embodiment, toggling feature 120 includes a pivot assembly, wherein a toggling base 121 is integrated with a pivoting apparatus 122, and selection mechanism 110 is configured to pivot about the pivot assembly to the first or second selecting positions. For example, toggling feature 120 includes toggling base 121, which is coupled with base structure 130, and pivoting apparatus 122 is coupled with toggling base 121. A portion of selection mechanism 110 facing base structure 130 is coupled with pivoting apparatus 122 such that selection mechanism 110 is able to pivot about toggling feature 120 based on an axis of rotation associated with pivoting apparatus 122.

With reference still to FIG. 1A, when a mechanical force 140 is applied to a left side 111 of selection mechanism 110, wherein mechanical force 140 is substantially parallel to a vector direction 150 toward base structure 130, a left-hand portion of selection mechanism 110, which corresponds to left side 111, rotates in a first rotational direction 151 towards base structure 130 to a first selecting position. In response to selection mechanism 110, or a portion thereof, being moved into this first position, a first function is initiated. In this manner, the positioning of selection mechanism 110 is changed so as to initiate or execute an available function.

Similarly, when a mechanical force 140 is applied to a right side 112 of selection mechanism 110, such as in a direction that is substantially parallel to a vector direction 150 toward base structure 130, a right-hand portion of selection mechanism 110, which corresponds to right side 112, rotates in a second rotational direction 152 towards base structure 130 to a second selecting position. Next, a second function is initiated in response to selection mechanism 110, or a portion thereof, being moved into this second position. In this manner, a single function selector may be implemented to select between multiple available functions.

Pursuant to one embodiment, selection mechanism 110 is configured to return to its initial, neutral position relative to base structure 130 after being displaced in one of the selecting positions. Consider the example where pivoting apparatus 122 includes a negative resistance mechanism, such as a spring. Mechanical force 140 is applied to a portion of selection mechanism 110 such that selection mechanism 110 is displaced into a selecting position, wherein mechanical force 140 is stronger than the negative force acting upon selection mechanism 110 by the negative resistance mechanism.

However, when mechanical force 140 is removed, or when the strength of mechanical force 140 is lessened to the degree that the negative force acting upon selection mechanism 110 is able to overcome the opposing mechanical force 140, selection mechanism 110 will consequently be returned to its initial, neutral position. In this manner, a function may be selected, and the selection mechanism will return to a neutral position such that the same, or another, function may be subsequently selected. This configuration allows for multiple function selections over time.

Various methods of initiating a function that is selected using selection mechanism 110 may be implemented. In one embodiment, and with reference again to FIG. 1A, first exemplary multi-function selecting mechanism 100 further includes a first input device 161 configured to initiate the first function in response to first input device 161 being selected, and a second input device 162 that initiates the second function when second input device 162 is selected. Moreover, selection mechanism 110 is utilized to select one of the aforementioned input devices, which may include electronic switching mechanisms, when selection mechanism 110 is moved to either the first or second selecting positions.

For example, with reference still to FIG. 1A, selection mechanism 110 includes a first selecting region 113 that is configured to select first input device 161 when selection mechanism is in the first selecting position. In particular, when selection mechanism 110 rotates in first rotational direction 151 to arrive at the first selecting position, first selecting region 113 physically contacts first input device 161, and this physical contact initiates a selection of first input device 161. In response to being selected, first input device 161 then initiates the first function. Similarly, when selection mechanism 110 rotates in second rotational direction 152 so as to be displaced in the second selecting position, second input device 162 is selected when a second selecting region 114 is brought into physical contact with second input device 162. As a result of this selection, second input device 162 initiates the second function.

Thus, selection mechanism 110 may be implemented so as to select one of a plurality of input devices that are mapped to various available functions such that the selection of one of these input devices using selection mechanism 110 causes the selected device to initiate a corresponding function. Although various types of input devices may be implemented, for purposes of illustration, an embodiment provides that first input device 161 and second input device 162 include buttons that are configured to be compressed, or depressed, in response to an applied mechanical force, and a selected function is initiated in response to such compression/depression.

For example, in one embodiment, first input device 161 and second input device 162 include compressible button domes. When mechanical force 140 is applied to left side 111, first selecting region 113 compresses the button dome of first input device 161. Similarly, second selecting region 114 compresses the button dome of second input device 162 when mechanical force 140 is applied to right side 112.

Moreover, an embodiment provides that when a button corresponding to first input device 161 is compressed, the first function is initiated, and when a button associated with second input device is compressed, the second function is initiated. In one exemplary electronic configuration, such a button may include electrical leads that are short circuited when the button is compressed, thus causing the button to transmit an electrical signal that signals an electronic processing system to initiate a specific function that has been mapped to the compressed button. In an alternative embodiment input devices used in conjunction with selection mechanism 110 use capacitive electrodes in order to store and dissipate an electrical charge, depending on whether the input devices are in a neutral or selected state.

The foregoing notwithstanding, an embodiment provides that first input device 161 and/or second input device 162 includes an input device that is different than a compressible button assembly. Consider the example where the implemented input devices include, or are communicatively coupled with, electromagnetic switching devices. Each of the available functions is mapped to one of these switching devices such that a selection of one of such device initiates a selection of the corresponding function. Moreover, selection mechanism 110 comprises a set of magnetic selecting devices that are configured to magnetically switch one of the electromagnetic switching devices when selection mechanism 110 is moved to either the first or second selecting positions. In response to being magnetically switched, the selected input device transmits an electronic signal used to initiate the selected function, wherein the selected function is mapped to the selected input device.

Pursuant to one embodiment, first exemplary multi-function selecting mechanism 100 is an indicator equipped multi-function selecting mechanism. For example, first exemplary multi-function selecting mechanism 100 provides a user with indications of the available functions that may be selected using selection mechanism 110. In this manner, the user may analyze the presented indications to determine which function the user will select, as well as how selection mechanism 110 is to be positioned so as to select the appropriate function.

To further illustrate, and with reference now to FIG. 1B, a first exemplary display mechanism 170 in accordance with an embodiment is shown. An indicator 180 is coupled with a top or visible portion of selection mechanism 110. A first portion 181 of indicator 180 provides a first indication associated with a first available function, while a second portion 182 of indicator 180 provides a second indication associated with a second function.

In an embodiment, indicator 180 provides physical protrusions or indentations used to communicate the functions that are selectable using selection mechanism 110. Consider the example where indicator 180 provides a number of physical protrusions in a Braille format. A user who is familiar with the corresponding Braille communication system will be able to decipher the symbols corresponding to the physical patterns of the protrusions upon touching these protrusions. In this manner, a visually impaired user who is familiar with Braille will be able to use selection mechanism 110 for its intended purpose.

In one embodiment, however, indicator 180 includes a display device configured to display images associated with the available functions that may be selected using selection mechanism 110. With reference still to FIG. 1B, indicator 180 is used to display a first indication in first portion 181, and a second indication in a second portion 182, wherein each indication includes an image representing its associated function. In the illustrated embodiment, the symbol “F1” is viewable in first portion 181, wherein the indication “F1” is used to communicate to a user that selection mechanism 110 may be used to select a first function. Similarly, the symbol “F2” may be viewed in second portion 182, wherein the indication “F2” communicates that a second function may be selected using selection mechanism 110.

The foregoing notwithstanding, in an embodiment, the indications provided by indicator 180 communicate which functions may be executed using selection mechanism 110, and simultaneously communicate how to position selection mechanism 110 so as to select such functions. With reference again to FIGS. 1A and 1B, an embodiment provides that first portion 181 is located above or adjacent to left side 111, whereas second portion 182 is located above or adjacent to right side 112. Thus, when a force, such as mechanical force 140, is applied to first portion 181 of indicator 180, left side 111 travels in first rotational direction 151 such that a first function corresponding to the symbol “F1” is initiated. This force may be the result, for example, of a user pressing down on first portion 181 of indicator 180. Similarly, if a user presses down upon, or applies a downward force to, second portion 182, right side 112 banks about toggling feature 120 in second rotational direction 152 such that a second function is initiated, wherein the second function is represented by “F2”.

Various display devices may be implemented in accordance with the present technology. Indeed, the present technology is not limited to the use of any single type of display device. For example, an embodiment provides that indicator 180 includes a display device selected from a group of display devices consisting of a light emitting diode (LED) display device, an organic light emitting diode (OLED) display device, a liquid crystal display (LCD) device, and an electronic ink device. However, other types of display devices may also be implemented with an indicator equipped multi-function selecting mechanism in accordance with the present technology.

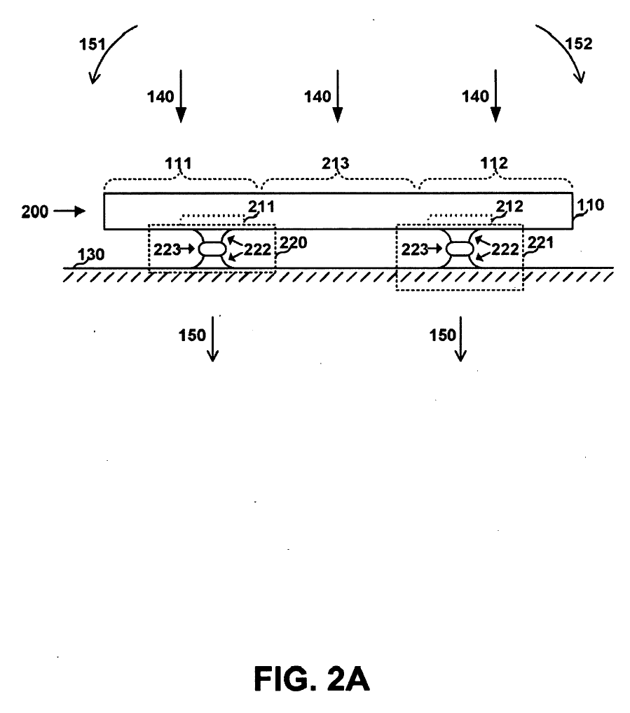

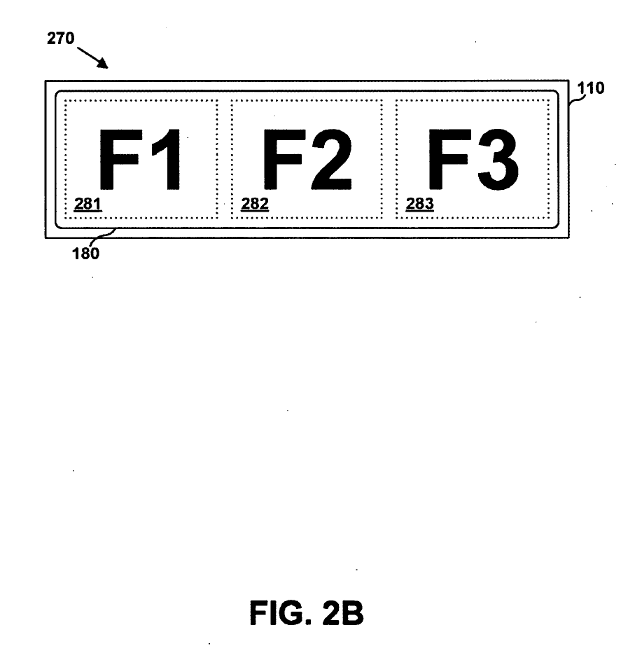

With reference now to FIG. 2A, a second exemplary multi-function selecting mechanism 200 in accordance with an embodiment is shown. Second exemplary multi-function selecting mechanism 200 includes a selection mechanism 110 coupled with a first toggling feature 220 and a second toggling feature 221. Selection mechanism 110 initially rests in a neutral position such that none of the available functions are selected. However, selection mechanism 110 is configured to move about first toggling feature 220 and second toggling feature 221 to a first position, a second position or a third position, with respect to a base structure 130.

Thus, one of three available functions may be initiated by moving selection mechanism 110 to one of these three selecting positions. In particular, a first function is initiated when selection mechanism 110 is in the first position, a second function is initiated when selection mechanism 110 is in the second position, and a third function is initiated when selection mechanism 110 is in the third position. In this manner, a single function selecting mechanism may be implemented to select three different functions.

To further illustrate, and with reference still to FIG. 2A, first toggling feature 220 and second toggling feature 221 are positioned between selection mechanism 110 and a base structure 130 such that the implemented toggling features support selection mechanism 110 relative to base structure 130. In particular, first toggling feature 220 is coupled with a first portion of selection mechanism 110, and second toggling feature 221 is coupled with a second portion of selection mechanism 110, such that each toggling feature provides a different mechanical anchor and support structure to selection mechanism 110.

In response to a mechanical force 140 applied to selection mechanism 110 selection mechanism 110 toggles about first toggling feature 220 and second toggling feature 221 to arrive at either the first, second or third selecting positions, depending on the position and vector direction of mechanical force 140 in relation to selection mechanism 110. For example, when mechanical force 140 is applied to a left side 111 of selection mechanism 110, first toggling feature 220 is compressed such that selection mechanism 110 rotates in a first rotational direction 151 to arrive at the first selecting position. Similarly, when mechanical force 140 is applied to a right side 112 of selection mechanism 110, selection mechanism 110 compresses second toggling feature 221 such that selection mechanism 110 is able to rotate in a second rotational direction 152 to arrive at the second selecting position.

However, whereas selection mechanism 110 is rotated about the toggling features to either the first or second positions, selection mechanism 110 is linearly displaced toward base structure 130 to arrive at the third selecting position. For example, mechanical force 140 is applied to a central portion 213 of selection mechanism 110. A characteristic mechanical rigidity of selection mechanism causes an amount of mechanical force 140 to be applied to each of the implemented toggling features such that first toggling feature 220 and second toggling feature 221 are both compressed between selection mechanism 110 and base structure 130. In this manner, both left side 111 and right side 112 of selection mechanism 110 travel toward base structure such that selection mechanism is linearly displaced into the third selecting position.

Although the previous embodiment describes the dislocation of selection mechanism 110 into the third selecting position in response to mechanical force 140 being applied to central portion 213, the present technology is not limited to this embodiment. For example, in an alternative embodiment, a different push force is applied to each of left side 111 and right side 112 such that a characteristic rigidity of the structure of selection mechanism 110 causes selection mechanism 110 to be linearly displaced so as to arrive in the third position.

The foregoing notwithstanding the toggling features may be implemented in different ways in accordance with the present technology. In one embodiment, each of the toggling features includes, or is communicatively coupled with, a different input device, such as a compressible button assembly configured to receive a binary input. The aggregated inputs that are captured using the various toggling features are then used to determine which function is to be initiated.

Consider the example where first toggling feature 220 includes a first input device and second toggling feature 221 includes a second input device. With respect to these two input devices, four possible selection states may be referenced. For example, the first input device is configured to initiate a first function in response to a selection of only the first input device, and the second input device is configured to initiate a second function in response to a selection of only the second input device. Moreover, the first and second input devices are further configured to initiate the third function in response to a selection of both of the first and second input devices. In this manner, the two input devices may be used to select a function from among three available functions. Finally, a fourth selection state exists when neither of the first or second input devices are selected, in which case second exemplary multi-function selecting mechanism 200 is in a neutral state.

Furthermore, a movement of selection mechanism 110 is used to select one of the available functions by changing a current selection state. For example selection mechanism 110 includes two selecting regions: a first selecting region 211 and a second selecting region 212. First selecting region 211 is coupled with the first input device, wherein first selecting region 211 is configured to select the first input device when selection mechanism 110 is in the first selecting position. In addition, second selecting region 212 is coupled with the second input device, wherein second selecting region 212 is configured to select a second input device when selection mechanism 110 is in the second position. Moreover, in an embodiment, first selecting region 211 and second selecting region 212 are further configured to select both of the first and second input devices when selection mechanism 110 is in the third position.

Various input devices and methods of implementation may be used in accordance with the present technology. With reference still to the embodiment shown in FIG. 2A, the toggling features include toggling base structures 222 having compressible button assemblies 223 coupled therewith. When mechanical force 140 is applied to a left side 111 of selection mechanism 110, such as in a direction substantially parallel to a vector direction 150 toward base structure 130, a left-hand portion of selection mechanism 110, which corresponds to left side 111, rotates in a first rotational direction 151 towards base structure 130 to a first selecting position. The rotation of this portion of selection mechanism 110 causes the button assembly of first toggling feature 220 to compress, which initiates a selection of the first input device. In response to this selection, a first function is initiated.

Similarly, when mechanical force 140 is applied to a right side 112 of selection mechanism 110, a right-hand portion of selection mechanism 110, which corresponds to right side 112, rotates in a second rotational direction 152 towards base structure 130 to a second selecting position. The rotation of this right-hand portion of selection mechanism 110 causes the button assembly of second toggling feature 221 to compress, which initiates a selection of the second input device. A second function is then initiated in response to this selection.

Furthermore, when mechanical force 140 is applied to central portion 213 of selection mechanism 110, both compressible button assemblies 223 are compressed so as to select both the first and second input devices. In response to this selection, a third function is initiated. Thus, each input device is mapped to more than one function, and the inputs received by these devices are analytically and logically aggregated so as to increase the number of available functions that may be mapped to these functions. This comprehensive logical input structure increases the number of functions that may be implemented using a single function selecting mechanism.

The foregoing notwithstanding, an embodiment provides that one or more of the implemented input devices includes an input device that is different than a compressible button assembly, such as an electromagnetic or optical switching device. Consider the example where an optical device is coupled with selection mechanism 110 such that a toggling of selection mechanism 110 about the toggling features disrupts an optical connection between a light source and a target. The disruption of this connection causes an electrical signal to be generated with is used to communicate that selection mechanism 110 has been moved in a particular direction about the toggling devices.

Pursuant to one embodiment, selection mechanism 110 is configured to return to its initial, neutral position relative to base structure 130 after being displaced in one of the selecting positions. Consider the example where first toggling feature 220 and second toggling feature 221 each include a negative resistance mechanism, such as a torsion spring. Mechanical force 140 is applied to a portion of selection mechanism 110, wherein mechanical force 140 is stronger than the negative force acting upon selection mechanism 110 by these torsion springs. Consequently, selection mechanism 110 compresses one or both of the toggling features, causing selection mechanism 110 to be displaced into a selecting position.

When mechanical force 140 is removed from selection mechanism 110, or when the strength of mechanical force 140 is lessened to the degree that the negative force exerted upon selection mechanism 110 by the torsion springs is able to overcome the opposing mechanical force 140, selection mechanism 110 consequently returns to its initial, neutral position. In this manner, a function may be selected, and selection mechanism 110 will return to a neutral position such that the same, or another, function may be subsequently selected. This configuration allows multiple function selections to occur over time.

Pursuant to one embodiment, second exemplary multi-function selecting mechanism 200 is an indicator equipped multi-function selecting mechanism that provides a user with indications of the available functions that may be selected using selection mechanism 110 as well as how selection mechanism 110 is to be positioned so as to select a particular function. With reference now to FIG. 2B, a second exemplary display configuration 270 in accordance with an embodiment is shown. An indicator 180 is coupled with a top or visible portion of selection mechanism 110. A first section 281 of indicator 180 provides a first indication associated with a first available function, a second section 282 of indicator 180 provides a second indication associated with a second function, and a third section 283 provides a third indication associated with a third function.

In an embodiment, indicator 180 includes a display device configured to display images associated with the available functions that may be selected using selection mechanism 110. With reference still to FIG. 1B, indicator 180 is used to display a first indication in first section 281, a second indication in second section 282, and a third indication in third section 283, wherein each indication includes an image representing its associated function. In the illustrated embodiment, the symbol “F1” is viewable in first section 281, wherein the indication “F1” is used to communicate to a user that selection mechanism 110 may be used to select a first function. Similarly, the symbols “F2” and “F3” may be viewed in second section 282 and third section 283, respectively, wherein the indications “F2” and “F3” communicate that second and third functions may be selected using selection mechanism 110.

The foregoing notwithstanding, in an embodiment, the indications provided by indicator 180 communicate which functions may be executed using selection mechanism 110, and simultaneously communicate how to position selection mechanism 110 so as to select such functions. With reference again to FIGS. 2A and 2B, first section 281 is located above or adjacent to left side 111. Thus, when a mechanical force, such as a force having a vector component substantially parallel to vector direction 150 is applied to first section 281 of indicator 180, left side 111 travels in first rotational direction 151 such that a first function corresponding to the symbol “F1” is initiated.

Furthermore, when a user presses or applies mechanical force 140 to second section 282, wherein second section is located above central portion 213, selection mechanism 110 is linearly displaced in a direction that is substantially parallel to vector direction 150, causing a second function, represented as “F2” in second section 282, to be initiated. Consider the example where a downward force is applied to central section 213 such that first toggling feature 220 and second toggling feature 221 are both compressed, and such that selection mechanism 110 arrives in the third selecting position. The compression of both of these toggling features is utilized to communicate a selection of the second function.

Finally, with reference still to FIG. 2A, third section 283 of indicator 180 is located above or adjacent to right side 112. If a user presses or applies a downward force to third section 283, right side 112 rotates in second rotational direction 152 such that a third function is initiated, wherein the third function is represented by “F3”. For example, when a user presses on third section 283, selection mechanism 110 rotates in second rotational direction 152, which causes second toggling feature 221 to be compressed between second selecting region 212 and base structure 130. First toggling feature 220, in contrast, remains uncompressed. In this manner, only second toggling feature 221 has been compressed, and the exclusive compression of second toggling feature 221 causes second function to be initiated.

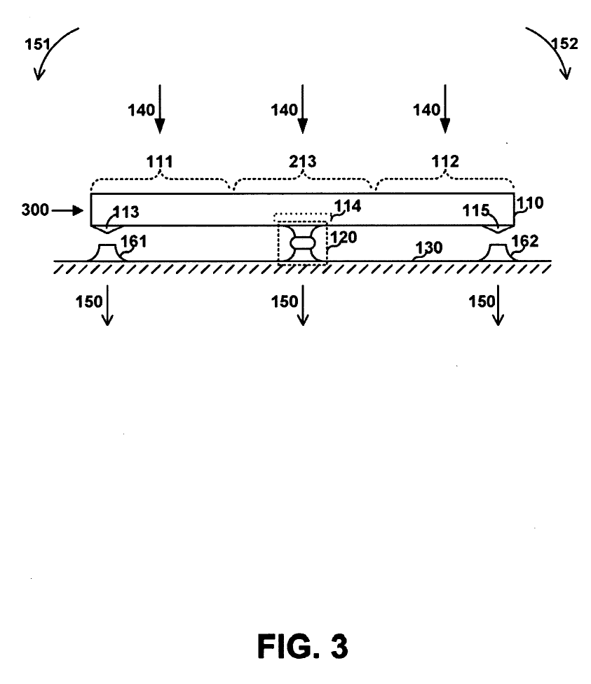

With reference now to FIG. 3, a third exemplary multi-function selecting mechanism 300 in accordance with an embodiment is shown. Third exemplary multi-function selecting mechanism 300 includes a selection mechanism 110 that is moveably coupled with a toggling feature 120. In particular, selection mechanism 110 is configured to move about toggling feature 120 to a first position, wherein a first function is initiated when selection mechanism 110 is in the first position. Selection mechanism 110 is further configured to move toward toggling feature 120 to a second position, which causes a second function to be initiated.

To further illustrate, and with reference still to FIG. 3, an embodiment provides that toggling feature 120 includes a pivot button assembly, which enables selection mechanism 110 to be moved in both rotational and linear directions with respect to base structure 130. Consider the example where selection mechanism includes a first selecting region 113 and a second selecting region 114. The pivot button assembly is coupled with second selecting region 114 at a point that faces base structure 130. Moreover, selection mechanism 110 is configured to pivot about the pivot button assembly in first rotational direction 151, such as when a mechanical force 140 is applied to left side 111 of selection mechanism 110, so as to arrive at the first selecting position. In this manner, the left side 111 and the right side 112 of selection mechanism 110 may each be rotated about the pivot button assembly. When selection mechanism 110 is adequately rotated to the first selecting position, the first function is consequently initiated.

In addition, the application of mechanical force 140 to a central portion 213 of selection mechanism 110 causes selection mechanism 110 to move toward base structure 130. In particular, this mechanical force 140 causes the pivot button assembly to be compressed between second selecting region 114 and base structure 130. Thus, when selection mechanism 110 is moved toward toggling feature 120 such as when a mechanical force 140 is applied to central portion 213, wherein mechanical force 140 is substantially parallel to a vector direction 150 toward base structure 130, selection mechanism 110 is displaced in the second selecting position, which causes the second function to be initiated.

Pursuant to one embodiment, selection mechanism 110 is further configured to move about toggling feature 120 to a third position, wherein a third function is initiated when selection mechanism 110 is in this third position. With reference still to FIG. 3, selection mechanism 110 is configured to pivot about toggling feature 120 in different directions. For example, when selection mechanism 110 pivots about toggling feature 120 in first rotational direction 151 to arrive at a first position, a first function associated with the first position is initiated. However, when selection mechanism 110 moves about toggling feature 120 in second rotational direction 152 to arrive at a third position, wherein the third position is different than the aforementioned second position, a third function is initiated. In this manner, a single function selecting mechanism may be configured to use a single toggling feature to select a function from among three available functions.

Moreover, in an embodiment, selection mechanism 110 is configured to return to its initial, neutral position relative to base structure 130 after being displaced in one of the selecting positions. Consider the example where toggling feature 120 includes a negative resistance mechanism such as a torsion spring. Mechanical force 140 is applied to a portion of selection mechanism 110 such that selection mechanism 110 is displaced into a selecting position, wherein mechanical force 140 is stronger than the negative force acting upon selection mechanism 110 by the torsion spring. When mechanical force 140 is removed from selection mechanism 110, or when the strength of mechanical force 140 is lessened to the degree that the negative force exerted upon selection mechanism 110 by the torsion spring is able to overcome the opposing mechanical force 140, selection mechanism 110 consequently returns to its initial, neutral position. In this manner, a function may be selected, and selection mechanism 110 will return to a neutral position such that the same, or another, function may be subsequently selected. This configuration allows multiple function selections to take place over time.

In one embodiment, and with reference again to FIG. 3, third exemplary multi-function selecting mechanism 300 further includes a first input device 161 configured to initiate the first function in response to first input device 161 being selected, and a second input device 162 that initiates the third function when second input device 162 is selected. Moreover, selection mechanism 110 is utilized to select one of the aforementioned input devices when selection mechanism 110 is moved to either the first or third positions.

For example, with reference still to FIG. 3, selection mechanism 110 includes a first selecting region 113 that is configured to select first input device 161 when selection mechanism 110 is in the first selecting position, and a third selecting region 115 that selects second input device 162 in response to selection mechanism 110 being displaced into the third selecting position. For example, when selection mechanism 110 rotates in first rotational direction 151 to arrive at the first selecting position, first selecting region 113 physically contacts first input device 161, and this physical contact initiates a selection of first input device 161. In response to being selected, first input device 161 then initiates the first function. Similarly, when selection mechanism 110 rotates in second rotational direction 152 so as to be displaced in the third selecting position, second input device 162 is selected when third selecting region 115 is brought into physical contact with second input device 162. As a result of this selection, second input device 162 initiates the third function.

Selection mechanism 110 further includes second selecting region 114, which is configured to select another input device when selection mechanism 110 is in the second position. Consider the example where toggling feature 120 includes an input device, and second selecting region 114 is used to select this input device when a user applies a force to central portion 213 of selection mechanism. In particular, when mechanical force 140 is applied to central portion 213, second selecting region 114 selects the input device by compressing toggling feature 120. In response to this selection, the second available function is then initiated. Thus, in contrast to the initiation of the first and third functions, which, in accordance with an embodiment, occurs in response to a pivoting of selection mechanism 110 about toggling feature 120, second function is initiated when selection mechanism 110 moves toward pivot assembly.

In one embodiment, the pivot button assembly includes a compressible button that is compressed when the selection mechanism is in the second position. For example, mechanical force 140 is applied to central portion 213 such that first selecting region 113 and second selecting region 114 both travel toward base structure 130, and such that the compressible button of the pivot button assembly is compressed between selection mechanism 110 and base structure 130 without first selection region 113 or second selecting region 114 coming into contact with first input device 161 or second input device 162, respectively. In this manner, once selection mechanism 110 has been displaced to the second selecting position, wherein the compressible button has been compressed, the second function is initiated in response to the compression of the aforementioned compressible button.

In an embodiment, an indicating device, such as indicator 180 of second exemplary display configuration 270, shown in FIG. 2A, is integrated with third exemplary multi-function selecting mechanism 300. This indicating device is coupled with selection mechanism 110 so as to provide indications associated with each of the three available functions that are selectable using selection mechanism 110. Moreover, a user may select the first function by pushing first section 281 of indicator 180, or the third function by pushing third section 283, in a direction toward base structure 130 such that selection mechanism 110, with which indicator 180 is coupled, rotates about toggling feature 120. The user may also select the second function by pushing second section 282 toward base structure 130 such that selection mechanism 110 moves toward toggling feature 120 into the second selecting position.

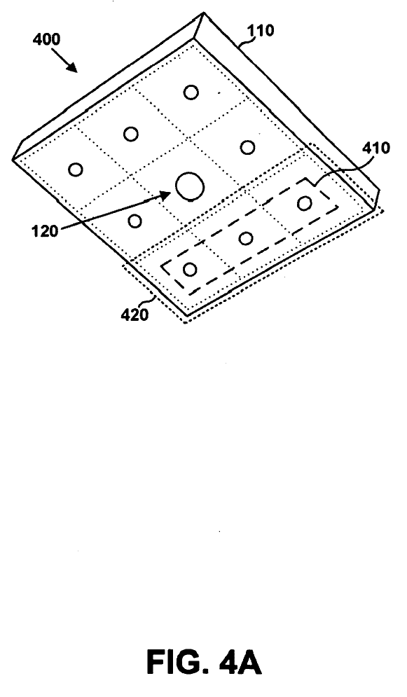

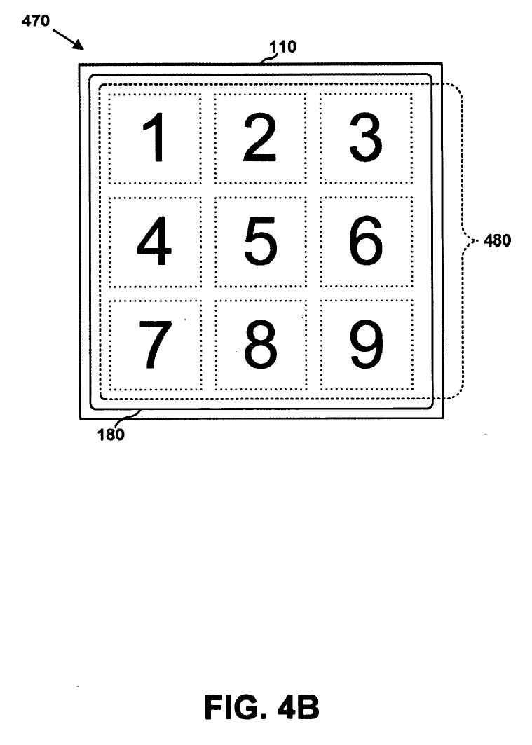

With reference now to FIG. 4A, a fourth exemplary multi-function selecting mechanism 400 in accordance with an embodiment is shown. Fourth exemplary multi-function selecting mechanism 400 includes a selection mechanism 110 configured to rotate about a toggling feature 120 in a number of directions. For example, in the illustrated embodiment toggling feature 120 is coupled with a central portion of a bottom side of selection mechanism 110. Moreover, selection mechanism 110 is configured to rotate in eight different directions about toggling feature 120 so as to select a function from among eight different available functions. Additionally, as will be described below, a ninth function can also be selected by moving selection mechanism 110 towards toggling feature 120 without substantially rotating selection mechanism 110 in any of the eight above-described directions.

To further illustrate, a number of input devices, such as exemplary input devices 410 are positioned adjacent to each of the eight outside regions of the bottom portion of selection mechanism 110, such as exemplary outside regions 420. One of these input devices is selected when selection mechanism 110 is rotated about toggling feature 120 such that a bottom outside region of selection mechanism 110 corresponding to such input device is moved toward the input device.

Furthermore, in an embodiment, toggling feature 120 includes a pivot button assembly, wherein the pivot button assembly may be compressed so as to initiate a ninth function. In this manner, toggling feature 120 acts as a focal point about which selection mechanism 110 is rotated to initiate one of eight possible functions, or may itself be selected by moving selection mechanism 110 in a linear direction toward toggling feature 120 such that toggling feature 120 is compressed. Therefore, whereas third exemplary multi-function selecting mechanism 300, shown in FIG. 3, is previously described as being configured to select between three available functions, an embodiment provides that the configuration of third exemplary multi-function selecting mechanism 300 may be expanded so as to provide selection mechanism 110 with a greater range of motion, thereby allowing selection mechanism 110 to communicate with an increased number of input devices so as to enable a user to select between a greater number of functions.

To further illustrate, an embodiment provides that fourth exemplary multi-function selecting mechanism 400 is integrated with an indicator or display device. With reference now to FIG. 4B, a third exemplary display configuration 470 in accordance with an embodiment is shown. Pursuant to third exemplary display configuration 470, selection mechanism 110 of FIG. 4A is coupled with an indicator 180, wherein indicator 180 is utilized to provide nine different indications associated with the functions that may be selected using selection mechanism 110.

Consider the example where selection mechanism 110 is utilized to input numerical digits into a software application. Selection mechanism 110 is coupled with indicator 180, wherein indicator 180 displays graphical representations of such numerical digits within a set of display regions 480. A user is therefore presented with the option of pushing on a particular display region from among set of display regions 480 so as to utilize selection mechanism 110 to select a particular numerical input. Thus, in contrast to a number pad having nine different input keys an embodiment provides that selection mechanism 110 may be used to select nine different digits. In this manner, a single input key may be implemented in a numerical input device so as to select between multiple possible numerical inputs.

Although third exemplary display configuration 470 has been described herein in the context of displaying numerical digits that may be selected using fourth exemplary multi-function selecting mechanism 400, the present technology is not limited to numerical selections or inputs. Indeed, fourth exemplary multi-function selecting mechanism 400 may be used to select between multiple non-numerical functions that are mapped to various implemented input devices, such as exemplary input devices 410.

Various multi-function selecting configurations have been described herein. Although exemplary implementations discussed herein are directed to selection mechanisms configured to move with respect to a base plane, the present technology is not limited to a simple rocker switch configuration. For example, as stated above, various embodiments are directed to selection mechanisms that are configured to be moved in different types of directions (e.g., linear and non-linear directions) with respect to a base plane.

Furthermore, various embodiments disclose integrating a multi-function selecting mechanism with an electronic display device so as to display multiple images associated with a plurality of available functions. This is in contrast to a different display device being used for each available function. Indeed, an embodiment provides that both the number of input keys and amount of electronic equipment used to select these functions may be minimized by using an indicator equipped multi-function selecting mechanism.

Consider the example where a different input key is used to select each of the available functions. Each of these input keys is coupled with an electronic indicator that provides an indication of the function mapped to the corresponding input key. Moreover, a different set of electronic driver equipment is used for each electronic indicator, which causes a relatively significant amount of driver equipment to be utilized.

Alternatively, an embodiment provides that a single input key is used to select multiple functions such that the amount of electronic driver equipment that is utilized may be significantly minimized. For example, a single electronic indicator device is integrated with a single input key such that the indicator provides indications associated with the functions that are selectable using this key. However, only a single set of device drivers is utilized to display images associated with these functions since only a single electronic indicator device is used in conjunction with the input key. Therefore, pursuant to one embodiment, the amount of equipment used to construct an electronic input device, such as a computer keyboard, is decreased, and consequently, the cost associated with manufacturing and/or purchasing such input devices may also be minimized.

### Exemplary Display Devices

Various display devices may be implemented in accordance with the present technology. Indeed, the present technology is not limited to the use of any single type of display device. For example, an embodiment provides that a display device integrated with an indicator equipped multi-function selecting mechanism, such as indicator 180 shown in FIGS. 1B, 2B and 4B, is a display device selected from a group of display devices consisting of a light emitting diode (LED) display device, an organic light emitting diode (OLED) display device, a liquid crystal display (LCD) device, and an electronic ink device.

For example, in an embodiment, indicator 180 includes an electronic ink display device, such as a bi-stable electronic paper display. The electronic ink display device displays images using an ink that carries an electric charge. The charged particles within the ink enable the display device to electronically change or update an image over time. In addition, the electronic ink display is able to achieve a relatively high level of contrast with respect to many other display devices, which increases the quality of a displayed image, thus causing the image to be easier to view.

Moreover, pursuant to one embodiment, the electronic ink display is configured to utilize relatively little power. Consider the example where the electronic ink display consumes power when a pixel within the display changes color, tint, or hue, but does not consume power when the displayed pixels do not change. Thus, an embodiment provides an indicator equipped multi-function selecting mechanism that is energy efficient such that system power may be conserved.

Furthermore, in an embodiment, the electronic ink display is configured to be extremely thin relative to other display devices. For example, the electronic ink display may be configured so as to have a thickness that is approximately as thin as a sheet of paper, such that the weight and bulkiness associated with indicator 180 may be minimized. In addition, in so much as indicator 180 is thinner and lower profile when compared to other display devices, the bulkiness of the indicator equipped multi-function selecting device is also minimized. Therefore, pursuant to one embodiment, multiple indicator equipped multi-function selecting devices are placed adjacent to one another, wherein each of the indicator equipped multi-function selecting devices is equipped with an electronic ink display. This allows the arrangement of these devices to be relatively tight and compact, so as to minimize the amount of space utilized by such an arrangement.

### Exemplary Computer System Environment

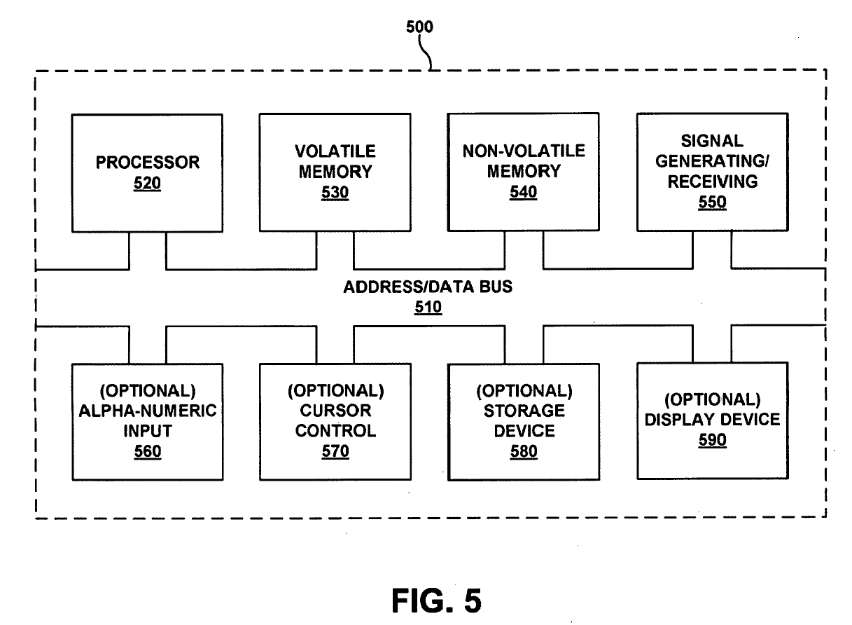

With reference now to FIG. 5, an exemplary computer system 500 in accordance with an embodiment is shown. Computer system 500 may be well suited to be any type of computing device (e.g., a computing device utilized to perform calculations, processes, operations, and functions associated with a program or algorithm). Within the discussions herein, certain processes and steps are discussed that are realized, pursuant to one embodiment, as a series of instructions, such as a software program, that reside within computer readable memory units and are executed by one or more processors of computer system 500. When executed, the instructions cause computer system 500 to perform specific actions and exhibit specific behavior described in various embodiments herein.

With reference still to FIG. 5, computer system 500 includes an address/data bus 510 for communicating information. In addition, one or more central processors, such as central processor 520, are coupled with address/data bus 510, wherein central processor 520 is used to process information and instructions. In an embodiment, central processor 520 is a microprocessor. However, the spirit and scope of the present technology is not limited to the use of microprocessors for processing information. Indeed, pursuant to one example, central processor 520 is a processor other than a microprocessor.

Computer system 500 further includes data storage features such as a computer-usable volatile memory unit 530, wherein computer-usable volatile memory unit 530 is coupled with address/data bus 510 and used to store information and instructions for central processor 520. In an embodiment, computer-usable volatile memory unit 530 includes random access memory (RAM), such as static RAM and/or dynamic RAM. Moreover, computer system 500 also includes a computer-usable non-volatile memory unit 540 coupled with address/data bus 510, wherein computer-usable non-volatile memory unit 540 stores static information and instructions for central processor 520. In an embodiment, computer-usable non-volatile memory unit 540 includes read-only memory (ROM), such as programmable ROM, flash memory, erasable programmable ROM (EPROM), and/or electrically erasable programmable ROM (EEPROM). The foregoing notwithstanding, the present technology is not limited to the use of the exemplary storage units discussed herein. Indeed, other types of memory may also be implemented.

With reference still to FIG. 5, computer system 500 also includes one or more signal generating and receiving devices 550 coupled with address/data bus 510 for enabling computer system 500 to interface with other electronic devices and computer systems. The communication interface(s) implemented by one or more signal generating and receiving devices 550 may utilize wired (e.g., serial cables, modems, and network adaptors) and/or wireless (e.g., wireless modems and wireless network adaptors) communication technologies.

In an embodiment, computer system 500 includes an optional alphanumeric input device 560 coupled with address/data bus 510, wherein optional alphanumeric input device 560 includes alphanumeric and function keys for communicating information and command selections to central processor 520. Moreover, pursuant to one embodiment, an optional cursor control device 570 is coupled with address/data bus 510, wherein optional cursor control device 570 is used for communicating user input information and command selections to central processor 520. Consider the example where optional cursor control device 570 is implemented using a mouse, a track-ball, a track-pad, an optical tracking device, or a touch screen. In a second example, a cursor is directed and/or activated in response to input from optional alphanumeric input device 560, such as when special keys or key sequence commands are executed. In an alterative embodiment, however, a cursor is directed by other means, such as, for example, voice commands.

With reference still to FIG. 5, computer system 500, pursuant to one embodiment, includes an optional computer-usable data storage device 580 coupled with address/data bus 510, wherein optional computer-usable data storage device 580 is used to store information and/or computer executable instructions. In an example, optional computer-usable data storage device 580 is a magnetic or optical disk drive, such as a hard drive, floppy diskette, compact disk-ROM (CD-ROM), or digital versatile disk (DVD).

Furthermore, in an embodiment, an optional display, device 590 is coupled with address/data bus 510, wherein optional display device 590 is used for displaying video and/or graphics. In one example, optional display device 590 is a cathode ray tube (CRT), liquid crystal display (LCD), field emission display (FED), plasma display or any other display device suitable for displaying video and/or graphic images and alphanumeric characters recognizable to a user.

Computer system 500 is presented herein as an exemplary computing environment in accordance with an embodiment. However, computer system 500 is not strictly limited to being a computer system. For example, an embodiment provides that computer system 500 represents a type of data processing analysis that may be used in accordance with various embodiments described herein. Moreover, other computing systems may also be implemented. Indeed, the spirit and scope of the present technology is not limited to any single data processing environment.

The above discussion has set forth the operation of various exemplary systems and devices, as well as various embodiments pertaining to exemplary methods of operating such systems and devices. In various embodiments, one or more steps of a method of implementation are carried out by a processor under the control of computer-readable and computer-executable instructions. Thus, in some embodiments, these methods are implemented via a computer, such as computer system 500 of FIG. 5.

In an embodiment, and with reference still to FIG. 5, the computer-readable and computer-executable instructions reside, for example, in data storage features such as computer-usable volatile memory unit 530, computer-usable non-volatile memory unit 540, or optional computer-usable data storage device 580 of computer system 500. Moreover, the computer-readable and computer-executable instructions, which may reside on computer useable/readable media, are used to control or operate in conjunction with, for example, a data processing unit, such as central processor 520.

Therefore, one or more operations of various embodiments may be controlled or implemented using computer-executable instructions, such as program modules, being executed by a computer. Generally, program modules include routines, programs, objects, components, data structures, etc., that perform particular tasks or implement particular abstract data types. In addition, the present technology may also be practiced in distributed computing environments where tasks are performed by remote processing devices that are linked through a communications network. In a distributed computing environment, program modules may be located in both local and remote computer-storage media including memory-storage devices.

Although specific steps of exemplary methods of implementation are disclosed herein, these steps are examples of steps that may be performed in accordance with various exemplary embodiments. That is, embodiments disclosed herein are well suited to performing various other steps or variations of the steps recited. Moreover, the steps disclosed herein may be performed in an order different than presented, and not all of the steps are necessarily performed in a particular embodiment.

Although various electronic and software based systems are discussed herein, these systems are merely examples of environments that might be utilized, and are not intended to suggest any limitation as to the scope of use or functionality of the present technology. Neither should such systems be interpreted as having any dependency or relation to any one or combination of components or functions illustrated in the disclosed examples.

Although the subject mater has been described in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. An indicator equipped multi-function selecting mechanism comprising:
a toggling feature;
a selection mechanism coupled with said toggling feature, said selection mechanism configured to move about said toggling feature to a first position or a second position, wherein a first function is initiated when said selection mechanism is in said first position and a second function is initiated when said selection mechanism is in said second position; and
an indicator coupled with said selection mechanism, said indicator providing a first indication associated with said first function and a second indication associated with said second function.

2. The indicator equipped multi-function selecting mechanism of claim 1, wherein said toggling feature comprises:
a pivot assembly, wherein said selection mechanism is configured to pivot about said pivot assembly to said first position or said second position.

3. The indicator equipped multi-function selecting mechanism of claim 1, wherein said selection mechanism comprises:
a first selecting region configured to select a first input device when said selection mechanism is in said first position, wherein a selection of said first input device initiates said first function; and
a second selecting region configured to select a second input device when said selection mechanism is in said second position, wherein a selection of said second input device initiates said second function.

4. The indicator equipped multi-function selecting mechanism of claim 1, wherein said first indication comprises:
a first image representing said first function;
and wherein said second indication comprises:
a second image representing said second function.

5. The indicator equipped multi-function selecting mechanism of claim 4, wherein said indicator comprises:
a display device configured to display said first and second images.

6. The indicator equipped multi-function selecting mechanism of claim 5, wherein said display device is selected from a group of display devices consisting of:
a light emitting diode (LED) display device, an organic light emitting diode (OLED) display device, a liquid crystal display (LCD) device, and an electronic ink display device.

7. A multi-function selecting mechanism comprising:
first and second toggling features; and
a selection mechanism coupled with said first and second toggling features said selection mechanism configured to move about said first and second toggling features to a first position, a second position or a third position, wherein a first function is initiated when said selection mechanism is in said first position, a second function is initiated when said selection mechanism is in said second position, and a third function is initiated when said selection mechanism is in said third position.

8. The multi-function selecting mechanism of claim 7, wherein said first toggling feature comprises:
a first input device configured to initiate said first function in response to a selection of only said first input device;
and wherein said second toggling feature comprises:
a second input device configured to initiate said second function in response to a selection of only said second input device.

9. The multi-function selecting mechanism of claim 8, wherein said first and second input devices are further configured to initiate said third function in response to a selection of both of said first and second input devices.

10. The multi-function selecting mechanism of claim 9, wherein said selection mechanism comprises:
a first selecting region coupled with said first input device, said first selecting region configured to select said first input device when said selection mechanism is in said first position; and
a second selecting region coupled with said second input device, said second selecting region configured to select a second input device when said selection mechanism is in said second position.

11. The multi-function selecting mechanism of claim 10, wherein said first and second selecting regions are further configured to select both of said first and second input devices when said selection mechanism is in said third position.

12. The multi-function selecting mechanism of claim 7, further comprising:
a base structure coupled with said first and second toggling features, wherein said first toggling feature is coupled with a first portion of said selection mechanism and said second toggling feature is coupled with a second portion of said selection mechanism such that said first and second toggling features support said selection mechanism relative to said base structure.

13. The multi-function selecting mechanism of claim 7, further comprising:
an indicator coupled with said selection mechanism, said indicator providing a first indication associated with said first function, a second indication associated with said second function, and a third indication associated with said third function.

14. A multi-function selecting mechanism comprising:
a toggling feature; and
a selection mechanism coupled with said toggling feature, said selection mechanism configured to move about said toggling feature to a first position or move toward said toggling feature to a second position, wherein a first function is initiated when said selection mechanism is in said first position and a second function is initiated when said selection mechanism is in said second position.

15. The multi-function selecting mechanism of claim 14, wherein said toggling feature comprises:
a pivot button assembly, wherein said selection mechanism is further configured to pivot about said pivot button assembly to said first position.

16. The multi-function selecting mechanism of claim 15, wherein said pivot button assembly comprises:
a compressible button that is compressed when said selection mechanism is in said second position, wherein said second function is initiated in response to said compressible button being compressed.

17. The multi-function selecting mechanism of claim 14, wherein said selection mechanism comprises:
a first selecting region configured to select a first input device when said selection mechanism is in said first position, wherein a selection of said first input device initiates said first function; and
a second selecting region configured to select a second input device when said selection mechanism is in said second position, wherein a selection of said second input device initiates said second function.

18. The multi-function selecting mechanism of claim 17, wherein said selection mechanism is further configured to move about said toggling feature to a third position, and wherein a third function is initiated when said selection mechanism is in said third position.

19. The multi-function selecting mechanism of claim 18, wherein said selection mechanism further comprises:
a third selecting region configured to select a third input device when said selection mechanism is in said third position, wherein a selection of said third input device initiates said third function.

20. The multi-function selecting mechanism of claim 19, further comprising:
an indicator coupled with said selection mechanism, said indicator providing a first indication associated with said first function, a second indication associated with said second function, and a third indication associated with said third function.
